(19) United States
(12) Patent Application Publication
(10) Pub. No.: US 2014/0291384 A1
(43) Pub. Date: Oct. 2, 2014

(54) Solder wire dispenser, a portable hand-held device to apply solder accuratel and without touching the solder wire.

(71) Applicant: Nelson Sigfrido Canelo, Santa Clarita, CA (US)

(72) Inventor: Nelson Sigfrido Canelo, Santa Clarita, CA (US)

(21) Appl. No.: 13/663,499

(22) Filed: Mar. 27, 2013

(51) Int. Cl. B23K 3/06

(52) U.S. Cl. CPC B23K 3/0615; B23K 3/063
USPC 228/101; 228/41; 228/7

(57) ABSTRACT

A hand-held device shaped as a pencil used for dispensing solder wire onto a soldering point. Such device contains a roll of solder wire that can be gradually extracted through a hole on the tip by pressing a button in forward motion to extract the solder without touching it. The device can be held in one hand and the dispensing of the solder wire is performed by an internal servo-mechanism that controls the amount of solder and the speed at which it is dispensed. The extracted solder can be pulled back into the device in order to retrieve small portions of the already extracted solder by pressing the same or a different button in backward motion in order to maintain a desired amount of solder outside the device. The device can be electrically powered by “AA” size batteries, or by an external power supply.

### TECHNICAL FIELD

The embodiments of the present disclosure relate to the technique or art of soldering or bonding electrical and electronic components to a Printed Circuit Board (PCB), or to a Printed Circuit Board Assembly (PCBA), or to the direct bonding of components together to form circuits.

### BACKGROUND OF THE INVENTION

As of the date of the creation of this invention, the technique or art of soldering electrical and or electronic components to a Printed Circuit Board (PCB), or to a PCB Assembly (PCBA), or to other components, has been carried out by amateur and professional personnel known herein as the “user” by applying the solder wire to the soldering area directly with their hands or fingertips. Such method makes the user come into direct contact with the material the solder is made of and which may contain harmful substances such as lead, solder flux, and other chemicals.

Another disadvantage of this method is that it relies on the user's ability to apply the correct amount of solder to the soldering point as it is melted by the already existing technology known as soldering gun or soldering pencil. Thus the user is required to manually pull the solder wire from a reel or from a small amount held in the user's hand in order to continuously apply the solder wire at a speed calculated by the user targeting to match the melting speed while applying the correct amount of solder onto the soldering point.

Such method requires the user to handle the solder directly with the hands, and to apply the correct amount and at the correct speed onto the soldering point to accomplish proper soldering.

The utility invention described hereinafter known as the “Solder Wire Dispenser” changes the above approach by providing the user with a hand-held device that contains the solder wire within its own enclosure and which integrates a servo-mechanism that releases the correct amount of solder wire required for soldering and at the correct speed for allowing it to melt by the pressing of one or more buttons on the device, thus keeping the user from touching the solder material and from self-estimating the proper amount of solder, or the required speed needed to accomplish proper results during soldering.

### SUMMARY OF THE DISCLOSURE

The embodiment of the present disclosure comprises of an apparatus used for applying solder wire onto a soldering point during the process of soldering electrical or electronic components, said apparatus comprises of:

A hand-held device that contains the solder within its enclosure keeping the user from touching the solder by allowing extraction and retraction of the solder wire with the pressing of one or more buttons on the device.

A servo-mechanism controlled by a built-in electronic circuitry that aids in dispensing a specific amount of solder wire and at a specific speed that is suitable for soldering electronic components.

A portable solution for carrying the solder wire and its applicator in one single piece of equipment that is portable when it is battery operated, or stationary when operated by an external power supply.

### DESCRIPTION OF THE DRAWINGS

FIG. 1: Shows all the external views of the invention, and identifies the views of top, side, front, and rear, and depicts the sectional planes used on the sectional views of FIGS. 2, and 3. Numeric labels in the drawing show points of interest that are explained in the “Detailed Description” section. The numbers of such labels match the numbers used on the other drawings when referred to the same part for easier understanding.

FIG. 2: Side sectional view from section “I-I” of FIG. 1. This figure shows all the parts that comprise the invention by exposing the inside of the device from the left side which shows all the parts either sectioned in half, or whole parts shown in the background of the right side of the device.

FIG. 3: Top sectional view from section “II-II” of FIG. 1. This figure shows the internal parts of the device from a top view angle and it is mainly used to clearly show the 90° angle between the gear from the stepper motor (FIG. 3, 15) to a second gear (FIG. 3, 16) that transmits motion to the rollers that move the solder wire.

FIG. 4: Exploded 3D Frontal View. This figure shows all the parts in a 3D view except for the DC-Input jack seen on FIG. 2, 19 that has been removed for clarity.

FIG. 5: Exploded 3D Rear View. This figure shows all the parts in a 3D view except for the DC-Input jack seen on FIG. 2, 19 that has been removed for clarity.

### DETAILED DESCRIPTION OF THE INVENTION

The utility invention described in this specification is referred to as Solder Wire Dispenser, or Solder Dispenser. The Solder Wire Dispenser is a hand-held device that facilitates the dispensing or the application of solder wire, also known as solder, onto the soldering area during the process of soldering electrical or electronic components. The Solder Wire Dispenser extracts the solder wire onto the soldering point where the electronic component is being soldered to the PCB or PCBA by holding the Solder Wire Dispenser in one hand and pressing a button with the fingertips to release or dispense the desired amount of solder wire.

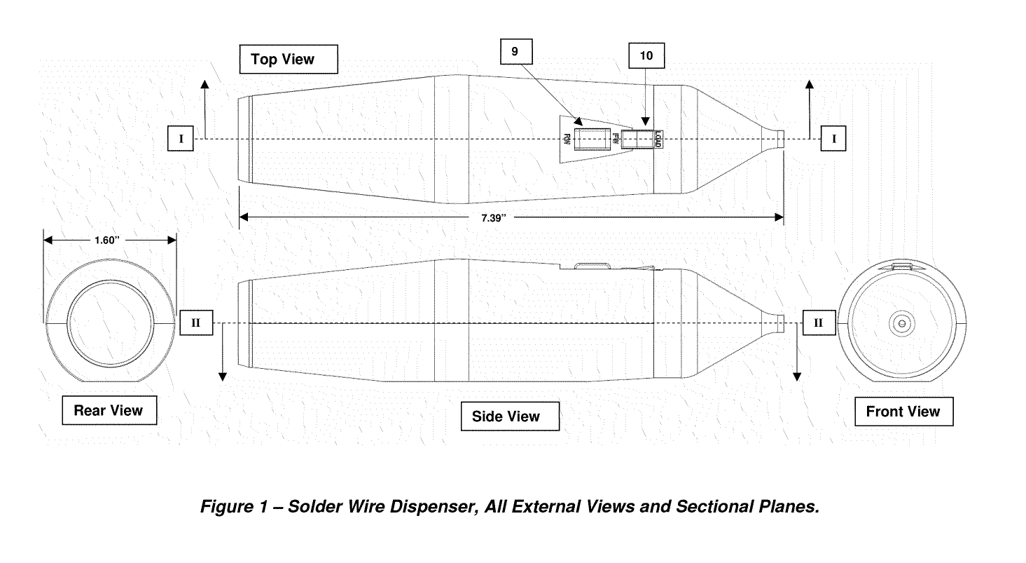

The Solder Wire Dispenser has the shape and size of a thick pen (FIG. 1) that can be held completely in one hand so that the user can use the other hand to hold down the soldering pencil or soldering gun which is an already existing tool that melts the solder wire during the soldering process.

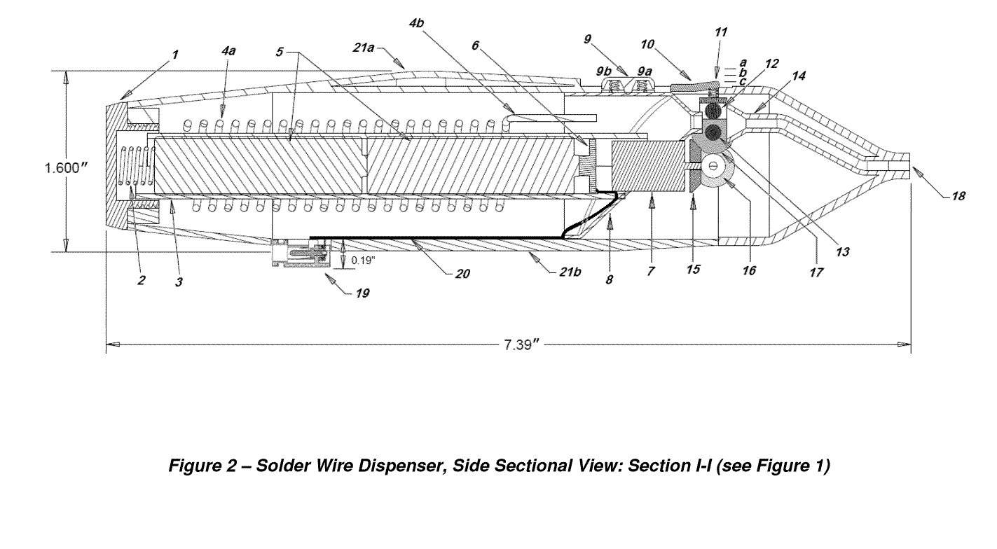

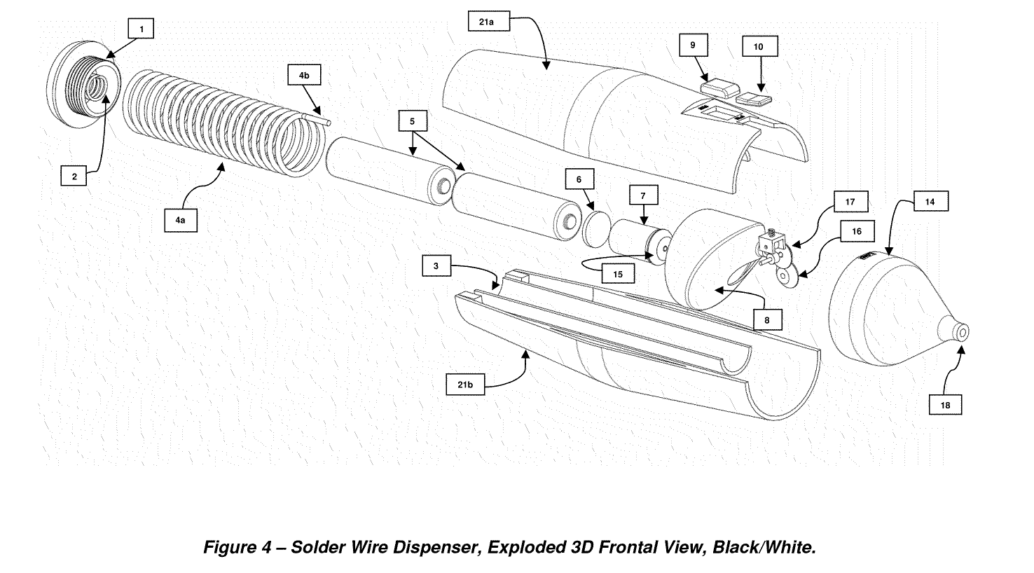

The Solder Wire Dispenser self-contains a considerable amount of solder wire in a form of a cylindrical roll (FIG. 4, 4a) inside its body. The device has a push button that allows the user extract the solder by pressing or tapping the button once on the “Forward” position (FIG. 1, 9 labeled “FW”, and FIG. 2, 9a). The solder is then automatically dispensed by the device at a speed of approximately 3.33 mm per second, extracting a maximum of 10 mm of solder in 3 seconds per tapping.

The user can stop the solder from being dispense at any time during the 3 seconds by pressing or tapping the same button once on the “Rewind” position (FIG. 1, 9 labeled “RW”, and FIG. 2, 9b). In order to continue dispensing more solder the user must continue tapping or pressing the button on the forward position as explained above.

For a continuous extraction of solder the user can tap on the forward button twice within an interval of one second, thus the device will extract 10 mm of solder at a speed of 3.33 mm/s and pausing extraction for 3 seconds every time it dispenses 10 mm of solder to allow the user to relocate the solder to another point and continue soldering.

In order to stop this continuous mode at any time the user must press or tap the forward button once, or the rewind button once.

Pressing the button on the forward position three times within one second period will enter the device on a “microscopic soldering” mode which consists of an extraction speed of 1.5 mm per second and an automatic pausing of the extraction every 5.0 mm of solder, for a period of 2 seconds, and continue. All of the above described automatic modes can be terminated by pressing or tapping on either the forward or the rewind button one time.

In order to retrieve any excess of solder protruding from the device the user can retract small portions of the extracted solder by pressing or tapping the push button once on the rewind position (FIG. 1, 9 labeled “RW”, and FIG. 2, 9b). This function gives capability of retracting the solder wire by a maximum of 30 mm of it.

The retracting function automatically makes the device retract solder at a speed of 3.33 mm/s and with portions of 5.0 mm after each tapping of the rewind button; thus maintaining a desired amount of solder outside the Solder Wire Dispenser and fine tuning the amount of solder being applied to the soldering point. This can be practical when storing the device, putting it away without leaving solder wire outside of it.

A second push button labeled “LOAD” (FIG. 2, 10, and FIG. 1, 10) facilitates the loading of a new roll of solder wire into the Solder Wire Dispenser by placing such button on the “LOAD” position (FIG. 2, 11a) and inserting a new roll of solder into the Solder Wire Dispenser. The same push button will lock the solder wire into place by pressing it to the positions 1 or 2 (FIG. 2, 11b or 11c, respectively) depending of which of the two different thickness or gauge of solder wire is being loaded to the device.

The “LOAD” button (FIG. 2, 10) allows to hold down the solder wire's straight end of the new roll (FIG. 2, 4b, and FIG. 4, 4b) so that the user can then press the “Forward” button (FIG. 1, 9 labeled “FW”, and FIG. 2, 9a) to extract the solder wire by traveling towards the tip of the Solder Wire Dispenser (FIG. 2, 18) in order to extract the solder and continue the soldering process.

The following is a description of the functions of the parts that constitute the Solder Wire Dispenser:

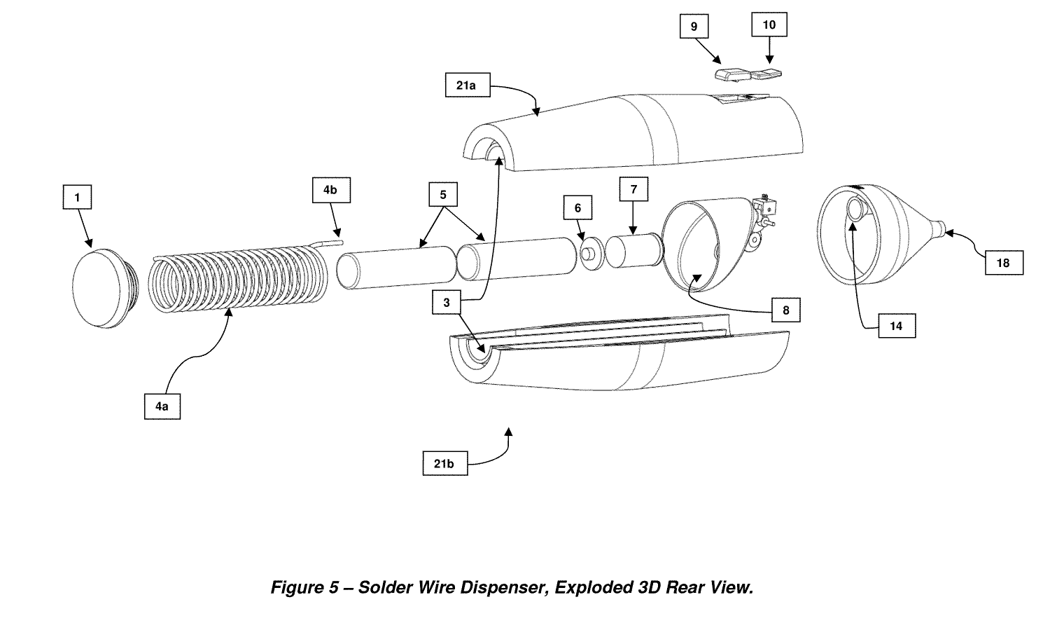

The source of electric power is obtained by either two type “AA” batteries (FIG. 2, 5, and FIG. 4, 5), or by an external 3.0 VDC/300 mA power supply connected to a DC jack below the device (FIG. 2, 19). The batteries are inserted into the battery cylinder (FIG. 2, 3, and FIG. 4, 3) which is exposed by removing the rear cap (FIG. 2, 1, and FIG. 4, 1). This cap has a battery spring terminal (FIG. 2, 2, and FIG. 4, 2) to bring the negative pole connection of the most outer battery to the electronic circuit PCBA, known in this specification as the “controller PCBA” (FIG. 2, 6, and FIG. 5, 6) via a wire located along the battery cylinder (FIG. 2, 3). The positive pole of the most inner battery makes contact with a battery terminal located at the controller PCBA.

When using an optional external power supply, a 4.8 mm diameter type of male mini-jack can be connected into the DC power supply receptacle (FIG. 2, 19) which is an off-the-shelf part that disconnects the battery circuit when an external jack is plugged in. Wires (FIG. 2, 20) located along the Solder Wire Dispenser's inner wall of its outer shell (FIG. 2, 21) bring electric power to the controller PCBA.

A roll of solder wire (FIG. 2, 4a, and FIG. 4, 4a) can be placed into the Solder Wire Dispenser by dropping it so that it falls wrapped around the battery cylinder (FIG. 2, 3, and FIG. 4, 3), preferably while putting the Solder Wire Dispenser in a vertical position with the tip (FIG. 2, 18) pointing down to ease the placement of solder roll by the force of gravity.

The straight end of the solder roll (FIG. 2, 4b, and FIG. 4, 4b) is then lined up so that it enters the opening at the end of a funnel shaped cone (FIG. 2, 8, and FIG. 5, 8) that directs the solder wire towards the mechanism designed to pull it through the tip opening (FIG. 2, 18).

The “LOAD” labeled button (FIG. 1, 10, and FIG. 2, 10) must be lifted at the highest position (FIG. 2, 11a) in order to allow the top roller (FIG. 2, 12) to permit the passage of the solder wire towards the exit point (FIG. 2, 18).

After the solder wire has been inserted passed the funnel shaped cone (FIG. 2, 8) opening, the “LOAD” button (FIG. 2, 10) must be pressed down to either of the two positions (FIGS. 2, 11b and 11c) which are designed, but not limited to, pressing down the solder wire from gauges 0.8 mm to 1.0 mm on position 1 (FIG. 2, 11b), or gauges 0.5 mm to 0.7 mm on position 2 (FIG. 2, 11c), respectively.

The top rubber roller presses the solder wire against the bottom rubber roller (FIG. 2, 13) which is the one applying the traction force to the solder wire in order to move it towards the exit point of the Solder Wire Dispenser when the FORWARD button is pressed (FIG. 2, 9a, and FIG. 1, 9 on “FW”), or to retract it inward when the REWIND button (FIG. 2, 9b, and FIG. 1, 9 on “RW”) is pressed.

During the installation of a new solder roll the FORWARD button must be pressed until the user determines that an acceptable amount of solder wire has protruded from the Solder Wire Dispenser.

When the user ceases to press either of the FORWARD, OR REWIND push buttons, the solder wire halts the extraction or retraction movement, respectively. The solder comes out from the tip (FIG. 2, 18) of the Solder Wire Dispenser in a straight line due to the channel provided in the tip which straightens the solder wire as it slides outward.

The function of the extraction or retraction of the solder wire described above is performed by a stepper motor connected to a helical-toothed gear (FIG. 2, 15, and FIG. 4, 15) call herein as GEAR1, designed to move another helical-toothed gear (FIG. 2, 16, and FIG. 4, 16), known herein as GEAR2, engaged in a 90° with GEAR1. The GEAR2 is also engaged with a third helical-toothed gear (FIG. 2, 17, and FIG. 4, 17) known as GEAR3, which is connected to the bottom rubber roller (FIG. 2, 13) which subsequently provides the forward or backward motion to push or pull the solder wire.

All of the above described gear system is moved by a stepper motor (FIG. 2, 7, and FIG. 4, 7) which is electrically managed by the controller PCBA when receiving the input signal from the user by pressing the FORWARD or REWIND push buttons.

The controller PCBA comprises of an off-the-shelf stepper motor driver integrated circuit (IC) which is electronically driven by an off-the-shelf microcontroller IC that runs a micro-code designed by the author of the invention specified herein. This micro-code, also known as firmware in the electronics industry, is a piece of software or programming instructions required to control the microcontroller IC and which is tailored with all the features to provide the timing signals that control the stepper motor requires to perform specific amount traction time and speed during the extraction or retraction of the solder wire in order to extract amounts required for soldering and at the required speed to allow the user performed the art of soldering electronic components properly.

This completes the functionality of all the parts that comprise the invention, as well as the operation procedure of the device in this invention, known as Solder Wire Dispenser.

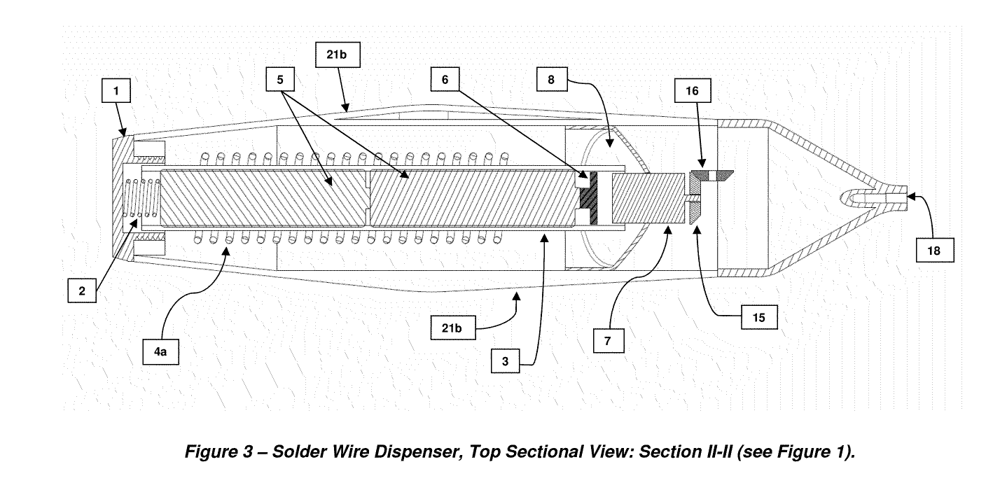

The material that the parts are made of are off-the-shelf materials found in the industry, such as 94V-0 non-flammable, thermoforming plastic for the main chassis of the device, and Aluminum 6061-T6 for the tip (FIG. 2, 18, or FIG. 3, 18) to avoid being accidentally melted or damaged by the use of a soldering pencil or gun during the soldering process.

An apparatus for applying solder wire onto a soldering point during the process of soldering electronic components, said apparatus comprises of:

1. A hand-held device that contains solder wire within its enclosure wherein the user can manipulate extraction or retraction of the solder wire without touching the solder material during the process of manual soldering of electronic components.

2. A method of claim 1, wherein:
the user can extract the solder wire by pressing one or more buttons in the device wherein a built-in electronic circuitry is activated in order to control a mechanism which extracts a specific amount of solder wire and at a specific speed.

3. A method of claim 1, wherein:
the user can retract the solder wire by pressing one or more buttons in the device wherein a built-in electronic circuitry is activated in order to control a mechanism which recoils back a specific amount of solder wire that remains outside the device and which is pulled back into the device at a specific speed.

4. The electronic circuit of claims 2 and 3 which comprises of a programmable microcontroller integrated circuit (IC) and a driver IC which drives a stepper motor attached to a mechanism wherein the microcontroller IC runs a firmware routine that provides the driver IC with the electrical signals that drive the stepper motor to make the mechanism pull in or pull out the exact amount of solder wire required to complete the functions described by claims 2 and 3.

5. The microcontroller IC of claim 4 which runs a firmware routine that provides the driver IC with the electrical signals that drive the stepper motor to make the mechanism extract or retract the solder wire at a specific speed or amount of millimeters of solder wire per second that is suitable for manual soldering of electronic components. This firmware routine allows for a variety of speeds and length of the solder wire being extracted or pulled back into the device in correlation to different tapping times or duration of the pressing of one or more buttons in the device.

6. A portable solution for carrying the solder wire and its applicator in one single piece of equipment that fits in one hand wherein full portability is possible by powering up the device by internal batteries.

7. A stationary solution for carrying the solder wire and its applicator in one single piece of equipment that fits in one hand when powering up the device by an external power supply station.

8. A device shaped as a pencil so that it can be handled by the user by one hand in an ergonomic manner during the soldering process.

9. A method used on claims 4 and 5 wherein:
a mechanism comprising of two or more rollers are attached to a set of gears to provide pushing and pulling traction to the solder wire and which is positioned in an off-centered location to avoid interference with the center axis of the device where the solder protrudes from the device.

10. A method used on claim 9 wherein:
a mechanism comprising of two or more rollers are attached to a set of gears whereas one of the rollers is movable to allow for the solder wire to be loaded to the device and which presses the solder wire in two or more selectable depth that allow for using two or more different gauges or thickness of solder wire.
